(19) United States
(12) Patent Application Publication
(10) Pub. No.: US 2025/0184205 A1
(43) Pub. Date: Jun. 5, 2025

(54) LATENT SUPPLEMENTARY PROTOCOL FOR ENHANCING PERFORMANCE & FUNCTIONALITY OF COMMUNICATION SYSTEMS

(71) Applicant: Intel Corporation, Santa Clara, CA (US)

(72) Inventors: Amir MEZER, Haifa (IL); Tal ISRAELI, Haifa (IL); Golan PERRY, Haifa (IL); Mor COHEN, Haifa (IL); Raz FROM, Moshav Hayogev (IL)

(21) Appl. No.: 19/043,924

(22) Filed: Feb. 3, 2025

(51) Int. Cl. H04L 27/34; H04L 25/49

(52) U.S. Cl. CPC H04L 27/3405; H04L 25/4917

(57) ABSTRACT

Methods and apparatus for a Latent Supplementary Protocol (LSP) for enhancing performance and functionality of communication systems. The LSP implements a PAM (Pulse Amplitude Modulation) 6 (PAM6) modulation scheme utilizing 36 constellation points comprising a multiplex of 32-QAM and shifted 32-QAM constellations, each comprising 32 PAM6 symbols. Supplementary data are added to constellation points comprising conveyors and shifted constellation points without affecting the bandwidth of transfer of payload data between link partners implementing the LSP. The supplementary data may be employed for various purposes, including but not limited to payload data protection, an auxiliary communication channel between link partners, and transfer of additional payload data.

### BACKGROUND INFORMATION

In modern high-speed wired communications systems, a SERDES (Serializer/Deserializer) is used to provide a target BER (Bit Error Rate) which meets specification requirements. Typical BER requirements vary between 2e-4 and 1e-12 (or even 1e-15), depending on the standard and application.

For a given standard, a modulation scheme to optimize BER for that standard should (preferably) be implemented. In classical PAM (Pulse Amplitude Modulation) schemes, it is common to encounter PAM with 2N levels, where N is a natural number. In such cases, each PAM symbol represents log 2 (2N)=N bits. In Ethernet, examples include 25 GBbE with PAM2 and 112 GbE and 224 GbE with PAM4. For 448 GbE, the exact modulation scheme has yet to be determined, but is trending towards PAM6. However, log 26 is not a natural number. Striving to achieve high efficiency and low complexity, a modulation scheme that maps 5 bits of data onto a “32-QAM” constellation based on PAM6 has been suggested and is currently under consideration for adoption.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a diagram of a 32-QAM gray mapping pattern;

FIG. 1a is a diagram of an alternative 32-QAM pattern;

FIG. 2 is a diagram illustrating a PAM6 modulation scheme where each 5 bits of payload data are mapped to 32 out of 36 constellation points of a 32-QAM constellation, according to one embodiment;

FIG. 2a is diagram a diagram showing an extension of the 32-QAM constellation employing conveyors and shifted constellation points, according to one embodiment;

FIG. 3 is a flowchart illustrating operations and logic implemented by a transmitter using the LSP to transmit payload data while conveying supplementary data in parallel, according to one embodiment;

FIG. 4 is a flowchart illustrating operations and logic implemented by a receiver using the LSP to receive and process the payload data and supplementary data transmitted from a transmitter, according to one embodiment;

FIG. 5 is a diagram of two graphs showing simulation results with LSP used for FEC-BER as a function of SNR with and without LSP-RS (depicted a raw BER);

FIG. 6 is a generalized LSP state machine diagram, according to one embodiment;

FIG. 7 is a flow diagram illustrating the flow of preparation of the supplementary data in a case where the LSP is used for error correction, according to one embodiment;

FIG. 8 is a diagram illustrating a sequence of 32-QAM and shifted 32-QAM constellations used to send payload data while conveying supplementary data from a transmitter to a receiver comprising a link partner, according to one embodiment; and

FIG. 9 is a diagram of a system architecture in which aspects of the LSP may be implemented.

### DETAILED DESCRIPTION

Embodiments of methods and apparatus for a Latent Supplementary Protocol (LSP) for enhancing performance and functionality of communication systems are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

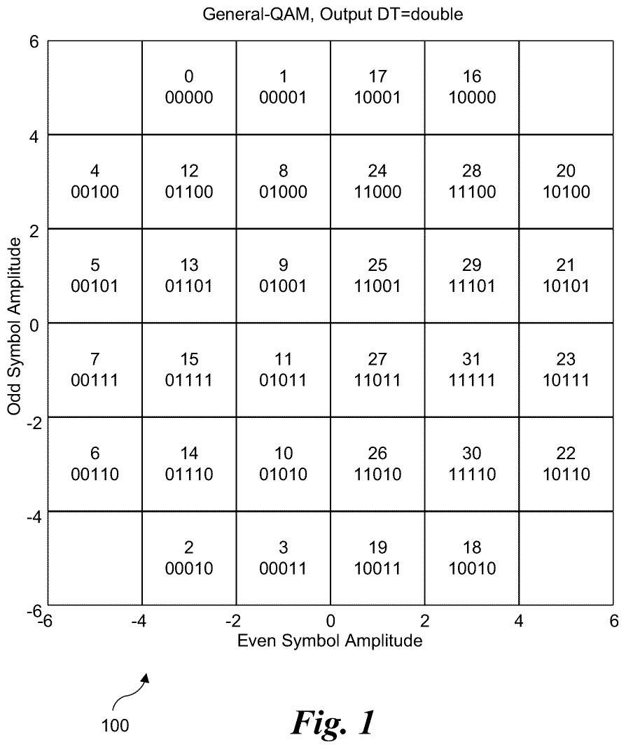

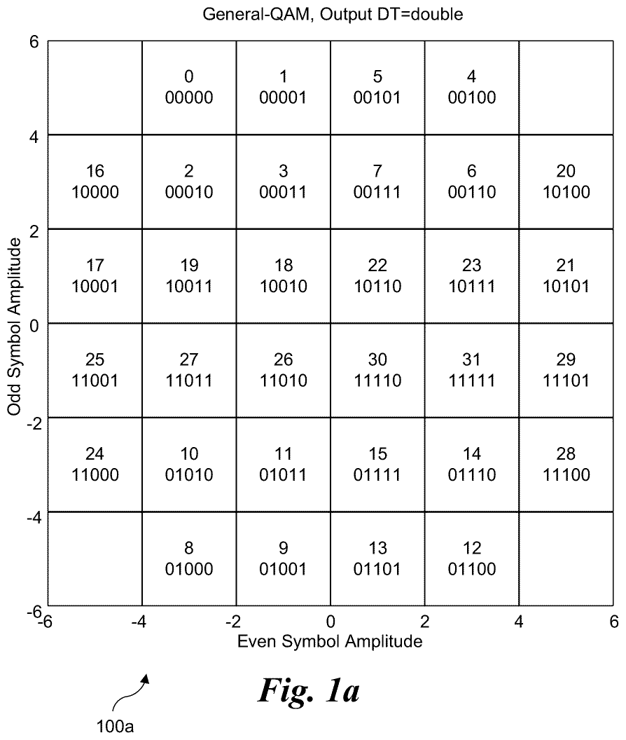

As mentioned above, a modulation scheme based on PAM6 is being considered for 448G Ethernet. Under this modulation scheme, each 5 bits are mapped onto 2 consecutive PAM6 symbols, resulting in 2.5 bits/symbol. An example of a “32-QAM” gray mapping pattern for such a scheme is shown in diagram 100 in FIG. 1, while an alternative “32-QAM” pattern is shown diagram 100a in FIG. 1a. For each one of the 32 constellation points, the conventional I and Q values are replaced by PAM6 even and odd symbol amplitudes and are transmitted consecutively. Note that the mapping of I and Q to 2 consecutive symbols is not typical QAM, where I and Q are real and imaginary values of the constellation, therefore the “32-QAM” used herein refers to a 32-QAM constellation structure comprising PAM6 symbols. Since there are 36 symbols on the full PAM6×PAM6 grid, 4 points need to be excluded. In the example patterns of FIGS. 1 and 1a, symbols that would occupy the corners of the PAM6×PAM6 grid are selected. Under other patterns, symbols other than those in the corners may be selected for exclusion.

In accordance with aspects of the embodiments disclosed herein, an LSP is introduced that exploits the unused constellation points to add a parallel supplementary data stream to the payload data stream without impacting the payload bandwidth nor any special signal processing requirements.

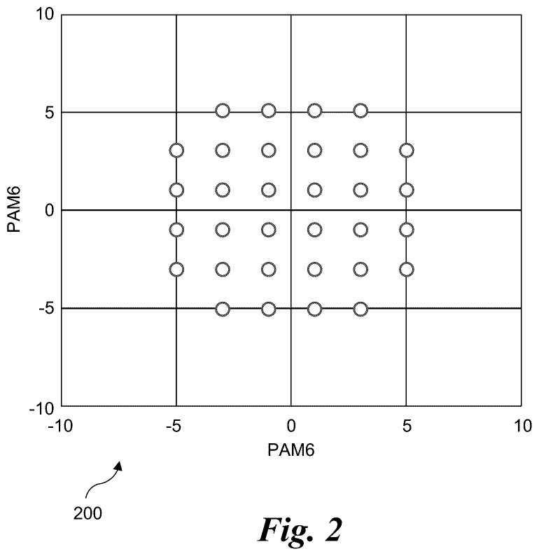

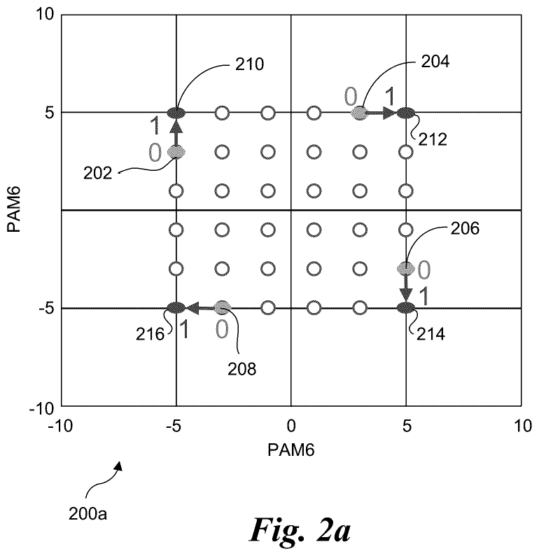

FIG. 2 shows a diagram 200 illustrating a PAM6 modulation scheme where each 5 bits of payload data are mapped to 32 out of 36 constellation points of a 32-QAM constellation, representing 2 consecutive symbols (odd/even on I/Q). In this example, the “corner” constellation points (located at the corners of the PAM6×PAM6 grid) are eliminated for optimization of SNR (signal to noise ration) but other constellation points may be eliminated under other embodiments. In this embodiment, these “corner” constellation points are used to covey supplemental data.

The Latent Supplementary Protocol is a latent (hidden) protocol since it does not alter the modulation scheme nor the digital signal processing and equalization schemes. TX (Transmit) and RX (Receive) symbols remain PAM6 symbols. The LSP opens the door to add numerous communication features between the TX and RX (including the option for a backchannel from RX to TX) with negligible impact on performance. Here are some examples of what can be included in the LSP:
Error correction codes, e.g. RS (Reed Solomon) or other block codes.
Channel for telemetry between TX and RX
Backchannel for special requests RX to TX
   For conveying messages to Link Partner TX, e.g. change TX parameters like power/filtration
   For conveying messages to Link Partner RX (e.g. handshake protocol)
A proprietary protocol which can be used if we have control both over TX and RX (either both are our own or an agreement between vendors)
Possibly higher throughput

Diagram 200a of FIG. 2a shows an example pattern used by an embodiment of the LSP. Four of the 32-QAM constellation points are used for conveying the protocol. These constellation points are referred to as “conveyors” and are depicted by conveyor constellation points 202, 204, 206, and 208. The supplementary data to be conveyed to the link partner is denoted as {S}. {S} is a stream of bits that are buffered in a FIFO or some other form of memory until the bits are transmitted.

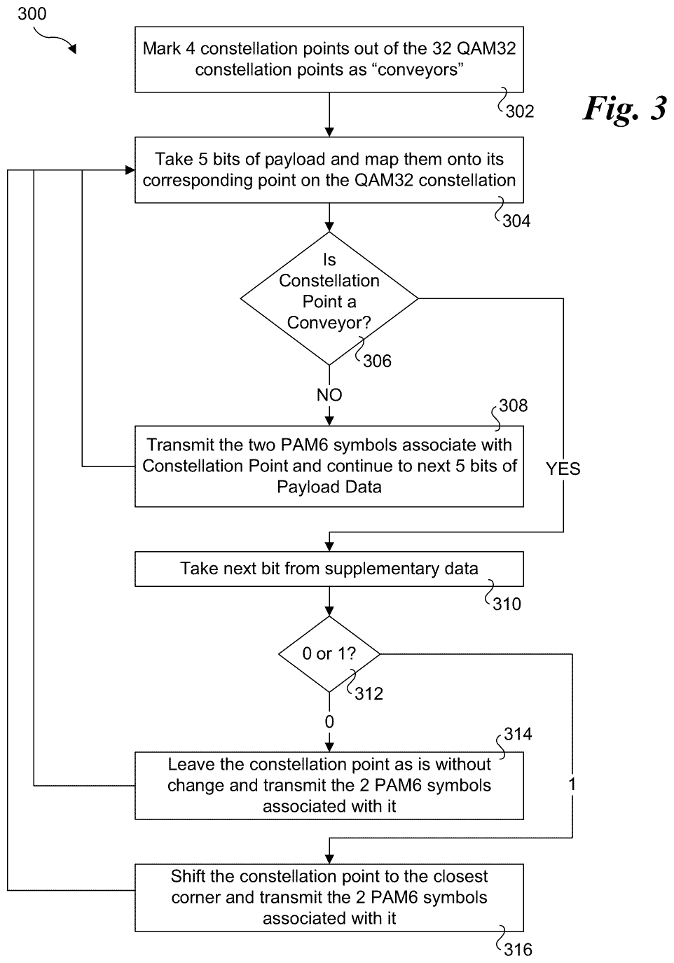

Flowchart 300 in FIG. 3 show operations and logic employed by a transmitter that transmits data at a rate of 448G using PAM6 modulation and 32-QAM. The process begins in a block 302 with 4 of the 32 constellation points marked or otherwise designated to be implemented as conveyors. From above, the conveyors are conveyor constellation points 202, 204, 206, and 208 in FIG. 2a. The remaining operations in flowchart 300 are performed on an ongoing basis during transmission of data from the transmitter to a receiver at a link partner.

In block 304, (a next) 5 bits of payload are taken and mapped onto its corresponding point in the 32-QAM constellation. In decision block 306 a determination is made to whether the constellation point is a conveyor. If it is not (a probability of 28/32), the answer is NO and the logic proceeds to block 308 in which the transmitter transmits the two PAM6 symbols associated with constellation point and continue to the next 5 bits of Payload Data, as depicted by the loop back to block 304.

When the constellation point is a conveyor, the answer to decision block 306 is YES and the logic proceeds to a block 310 where the next bit is taken from the supplementary data. In a decision block 312 a determination is made to whether that next bit is a ‘0’ or a ‘1’. If it is a ‘0’, the logic proceeds to block 314 where the constellation point is left as is without change and the transmitter transmits the 2 PAM6 symbols associated with the constellation point. When the next bit is a ‘1’, the logic proceeds to a block 316 in which the constellation point is shifted to the closest corner and the transmitter transmits the 2 PAM6 symbols associated with the shifted constellation point. Examples of shifted constellation points 210, 212, 214, and 216 are shown in FIG. 2a. For each of blocks 314 and 316, upon completion of the operations in the block the logic loops back to block 304 to process the next 5 bits of payload.

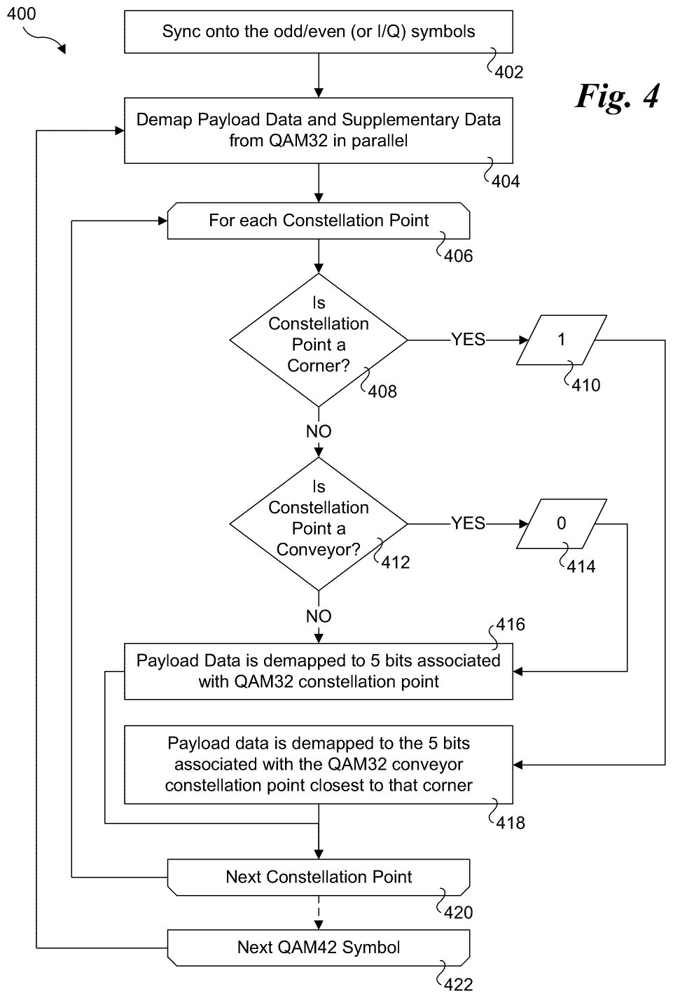

FIG. 4 shows operations and logic performed at a receiver (link partner) of the transmitted 32-QAM signal, according to one embodiment. In a block 402 the receiver is synched onto the odd/even (or I/Q) symbols. As shown by the outer and inner loops, the operations and logic depicted within the loops are performed for each 32-QAM symbol (outer loop) and each constellation point in that 32-QAM symbol (inner loop).

The outer loop begins in a block 404 in which the payload data and supplementary data from the 32-QAM symbol are demapped in parallel, with the operations and logic illustrated below block 404 depicting how the parallel demapping is performed. As shown by inner start loop and end loop blocks 406 and 420, the operations within the inner loop are performed for each constellation point.

In a decision block 408 a determination is made to whether the constellation point is a corner. If the answer is YES, a bit value of ‘1’ is added to the supplementary data stream, as shown by data 410, and the logic proceeds to a block 418 in which the payload data is demapped to the 5 bits associated with the 32-QAM conveyor constellation point closest to that corner. The logic then proceeds to end loop block 420, which loops back to start loop block 406 to begin processing of the next constellation point.

Returning to decision block 408, if the constellation point is not a corner the answer is NO and the logic proceeds to a decision block 412 in which a determination is made to whether the constellation point is a conveyor. If the answer is YES, bit value of ‘0’ is added to the supplementary data stream, as shown by data 414. For both a YES and NO answer to decision block 412, the logic will proceed to a block 416 in which the payload data is demapped to 5 bits associated with the 32-QAM constellation point. The logic then proceeds to end loop block 420, looping back to start loop block 406. The operations and logic in the inner loop are performed for each constellation point in a current 32-QAM symbol and once completed processing for next 32-QAM symbol will begin, as depicted by outer loop end block 422.

Under the embodiments disclosed herein, the data remains PAM6 on each and every individual symbol, thus not requiring any changes in the signal processing (transmitter, TXFFE, receiver, equalizers). In addition, the supplementary data stream is transmitted in parallel, without impacting the payload data stream rate at all. Hence the word “Latent” is added to the protocol name. The supplementary data should have some delimiters so that the receiver is able to synchronize onto it, hence the word “Protocol” was also added to its name.

There are several usage models of the LSP that have been developed or are envisioned. One usage model that has been implemented is for error correction, by placing FEC (Forward Error Correction) onto the supplementary data stream. Under different embodiments, there can be either one level of protection of the payload data only, where the supplementary data conveys the FEC required to protect the payload data, or a nested code (a.k.a. Product code), where there are two levels of protection, one code protecting the payload data and one code protecting the supplementary data. The second level of protection is independent of the first. Examples include CRC (Cyclic Redundancy Check), Bose-Chaudhuri-Hocquenghem (BCH) codes, etc. Under a two-level protection scheme, part of the supplementary data rate is dedicated for the second level of protection.

There is a range of possible codes that may be selected and utilized under the techniques and principles disclosed herein. One example that was selected and simulated is a one-level RS FEC code over a GF (8) (Galois field with 8 elements, aka GF (2\hat{ }8)) alphabet, where each symbol is represented by 8 bits. The message length selected was K=240 symbols. On average, there were 6 parity symbols per message, so N=246. The correction capability of this code is 3 symbols (8 bits each). Note that the rate of the code (parity symbols) should on average be≤1/40 of the data rate to be able to support the coding scheme.

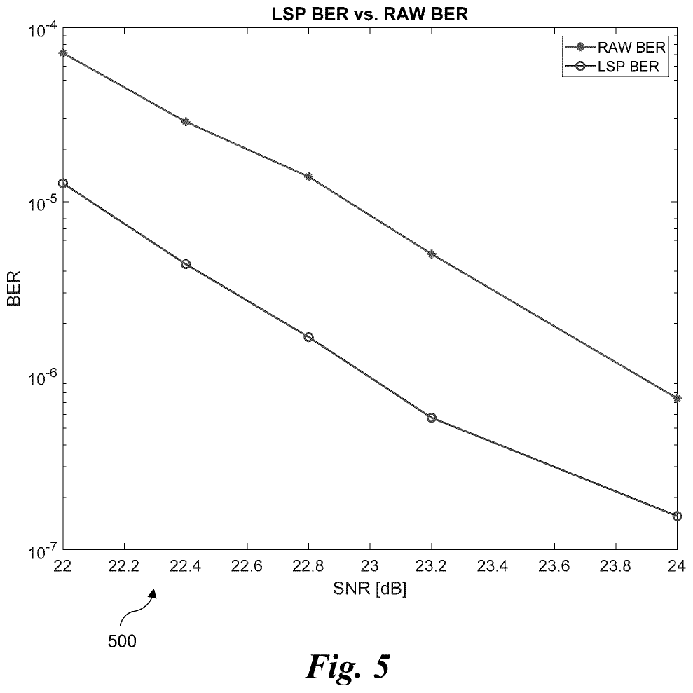

FIG. 5 is a diagram 500 of two graphs showing simulation results with LSP used for FEC-BER as a function of SNR with and without LSP-RS (depicted a raw BER). As can be seen from the graphs, using the above LSP-RS scheme enhances performance by approximately 1 dB. These are preliminary simulation results with the ability to achieve even lower BER.

Generally, FEC may be applied either on the symbol-by-symbol DFE receiver or on the MLSD (Maximum Likelihood Sequence Detection) output. The RS is especially effective in dealing with bursts of error since they are packed into a small number of RS symbols that are impacted. Both the DFE receiver and the MLSD receivers are characterized by errors that typically appear in bursts. Currently, LSP with a stronger RS nested code is under investigation.

An additional usage model (generalized beyond FEC) is to use the supplementary data stream to communicate between the transmitter and the receiver. It can be a 2-way protocol, e.g., a training protocol can be used (similar to that in previous Ethernet standards), or a telemetry protocol (where the transmitter conveys supplementary information such as gain, filter bandwidth, etc.) but without paying a penalty in data rate. Since the protocol does not hurt the payload data, it can be conveyed in parallel to it, without having to add a training phase before link establishment.

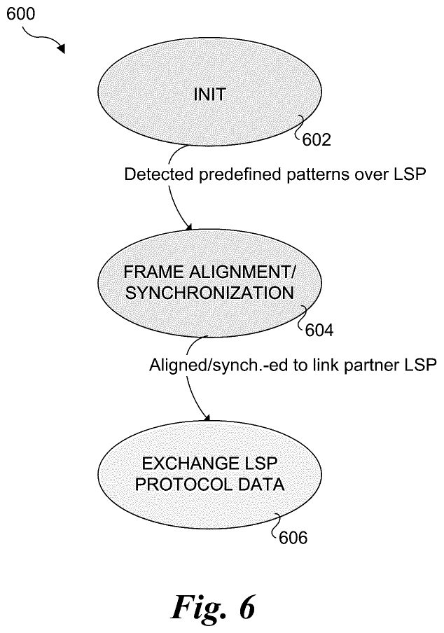

FIG. 6 shows a state machine for implementing generalization of a protocol, which can be added using the supplementary data stream. This is just one example and may be expanded to numerous different protocols.

The protocol is defined by a state machine 600 that propagates with events and handshake messages between the 2 link partners. The first state 602, includes initial predefined patterns for link establishment. After both sides have established the link, the state machine moves to a frame alignment/synchronization state 604. After this is achieved, we can start with communicating the desired protocol over LSP between the two sides, as depicted by exchange LSP protocol data state 606.

Under another example use case of the supplementary data, the supplementary data is used to expand the payload throughput by 1/40.

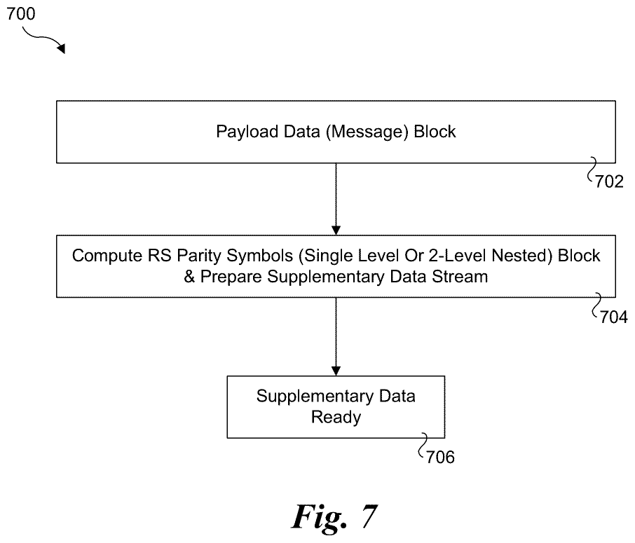

FIG. 7 shows a flow diagram 700 illustrating the flow of preparation of the supplementary data in a case where the LSP is used for error correction, according to one embodiment. In a block 702, payload data is added to a payload data block or payload data message block. In a block 704, the RS parity symbols (single-level or 2-level nested) block is computed and prepared to be added to the supplementary data stream. As shown in block 706, the supplementary data for the block is now ready to be added to the transmitter output to be conveyed in parallel with the payload data block. When LSP conveys a FEC, some latency may be added if a block code is selected, since computation of the parity symbols requires observation of an entire payload data block.

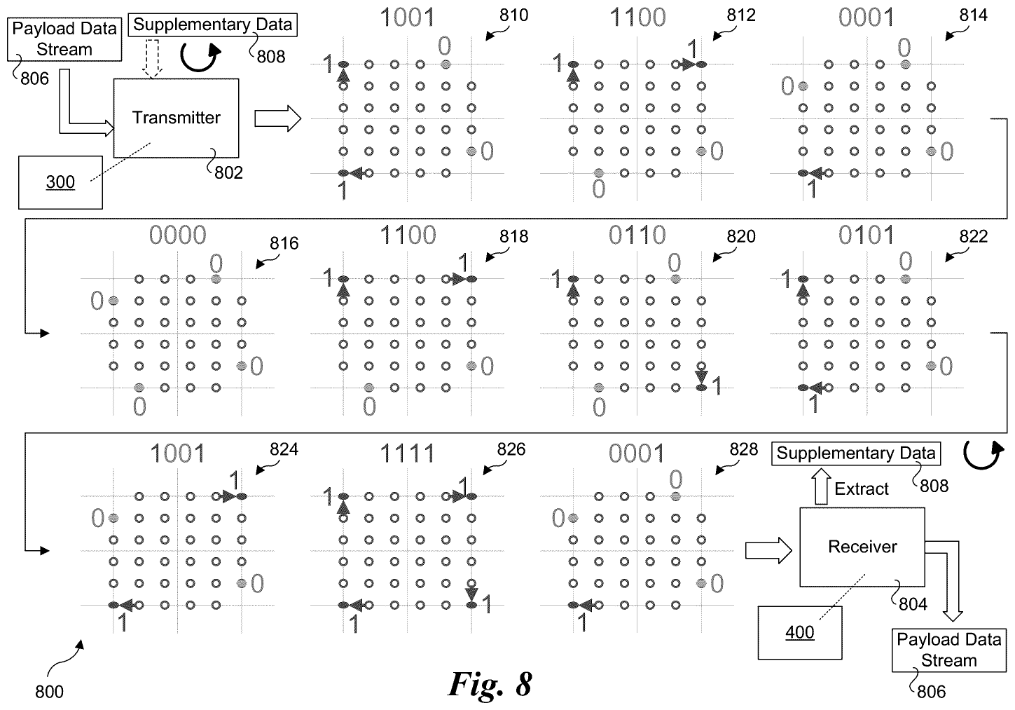

FIG. 8 shows a system 800 including a transmitter 802 that transmits a sequence of 32-QAM constellations and shifted 32-QAM constellations to a receiver 804, where transmitter 802 and receiver 804 are operated as link partners. Transmitter 802 includes circuitry for implementing transmitter-side aspects of the LSP and includes embedded logic for implementing the operations and logic of flowchart 300 shown in FIG. 3 and discussed above. Receiver 804 includes circuitry for implementing receiver-side aspects of the LSP and includes embedded logic for implementing the operations and logic of flowchart 400 shown in FIG. 4 and discussed above. In practice, system 800 may include a pair of transceivers operating as link partner, with each transceiver including a transmitter 802 and a receiver 804.

Transmitter 802 includes an input for receiving a payload data stream 806. Transmitter 802 may also include an input for receiving supplementary data 808 (optional) and/or may generate supplementary data 808 as a function of data in payload data stream 806, such as one level or nested two level error protection codes described above.

As transmitter 802 receives blocks of payload data in payload data stream 806, it implements the operations and logic of flowchart 300 and outputs the sequence of 32-QAM and shifted 32-QAM constellations 810, 812, 814, 816, 818, 820, 822, 824, 826, and 828. As used herein, a 32-QAM constellation does not have any shifted constellation points. For example, constellation 816 is a 32-QAM constellation. A shifted 32-QAM constellation includes one or more shifted constellation points. Thus, each of constellations 810, 812, 814, 818, 820, 822, 824, 826, and 828 is a shifted 32-QAM constellation. In this example, the sequence of supplementary data bits is 1001, 1100, 0001, 0000, 1100, 0110, 0101, 1001, 1111, and 0001 for respective constellations 810, 812, 814, 816, 818, 820, 822, 824, 826, and 828.

As will be recognized by those skilled in the art, the number of bits per block of payload data used for an error code or other error protection scheme may vary, depending on what code/scheme is used. In some cases, the error code will require more than 4 bits per 32 5-bit (160 bits) of payload data, recognizing a payload data block may span multiple 32-QAM and/or shifted 32-QAM constellations. In such cases, an LSP implementation may use a portion of the payload data for a portion of the error code, combining that portion of error code with the error code data in the supplementary data. In some cases, if there is not enough “space” to add the RS parity symbols in a certain block, the block is transmitted without FEC.

In other cases, the size of the data block may be such that not all the supplementary data is needed. For example, if a data block is >1280 bits and a CRC32 code is used, then the supplementary data beyond the first 8 32-QAM and/or shifted 32-QAM constellations will not be needed. As the link partners at the ends of the link will know what LSP error code is being used, this may be easily handled.

Under another approach, the utilization of conveyed data bits for data protection may be varied as a function of BER. The BER may be dynamically determined, with the data protection scheme utilizing for conveyed data bits if the BER exceeds a target threshold. Optionally, BER could be measured using a given environment (such as in a data center rack), and a data protection scheme could be tuned to meet a target BER. In another embodiment, depending on the BER or other measure of link quality, FEC (Forward Error Correction) may be enabled or disabled. When enabled, the FEC data may be transmitted using the conveyor constellation points. A device may also dynamically determine what data and/or protocol to communicate using the conveyor points.

It will further be recognized, that in most instances when the supplementary data 808 are generated as a function of data in the payload data stream, the supplementary data will be generated over payload data to be contained in multiple 32-QAM and/or shifted 32-QAM constellations. Thus, transmitter 802 may contain one or more levels of buffers in which blocks of payload data are temporarily stored.

At the receiving end, receiver 804 demaps the payload data and extracts supplementary data 808 from the received 32-QAM and/or shifted 32-QAM constellations using embedded logic for implementing the operations and logic of flowchart 400 discussed above with reference to FIG. 4. Receiver 804 will output payload data stream 806, which will match payload data stream 806 received by transmitter 802 if there are no transmission errors, which will be detected using error code(s) in supplementary data 808. As with generation of the error code(s) on the transmission side, the error code(s) will be applied to received payload data spanning multiple 32-QAM and/or shifted 32-QAM constellations. Receiver 804 may include one or more levels of buffers to temporarily store the received payload data and extracted supplementary data.

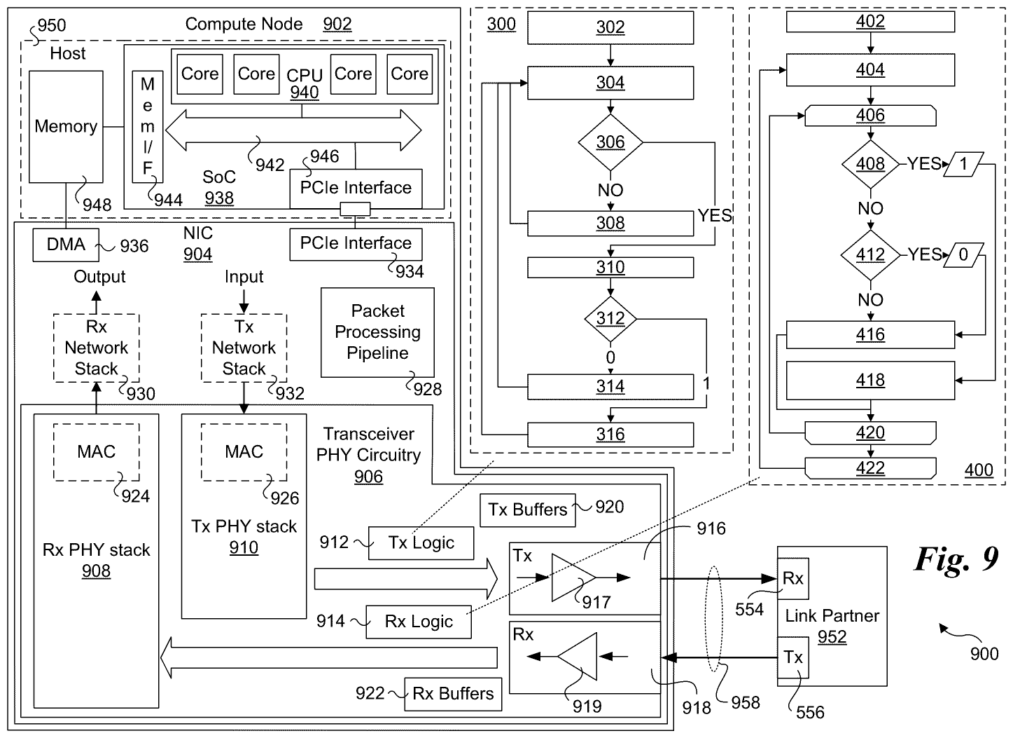

FIG. 9 shows a diagram of a system architecture 900 including a compute node 902 having a Network Interface Controller 904 and transceiver PHY (Physical Layer) circuitry 906. Transceiver PHY circuitry 906 includes an Rx PHY stack 908, a Tx PHY stack 910, Tx logic 912, Rx logic 914, a transmitter port 916 including transmitter circuitry 917, a receiver port 918 including receiver circuitry 919, Tx buffers 920, and Rx buffers 922. Rx PHY stack 908 and Tx PHY stack 910 may include layers/sublayers for implementing an existing or future high-speed Ethernet protocol. For example, these PHY stacks may include a Physical Coding Sublayer (PCS) module, an FEC module including an FEC decoder, a Physical Media Attachment (PMA) module, and a Physical Media Dependent (PMD) module.

Tx logic 912 comprises embedded logic configured to implement the operations and logic of flowchart 300 of FIG. 3, as discussed above. The Tx logic may employ one or more buffers depicted as Tx buffers 920. Similarly, Rx logic 914 comprises embedded logic configured to implement the operations and logic of flowchart 400 of FIG. 4, as discussed above. The Rx logic may employ one or more buffers depicted as Rx buffers 922.

Generally, transceiver PHY circuitry 906 may be implemented as an integrated circuit (IC), such as a PHY chip. In some embodiments transceiver PHY circuitry 906 further includes MAC (Media Access Channel) circuitry/modules 924 and 926, and the chip is a PHY/MAC chip. In other embodiments, MAC layer circuitry is implemented separate from a PHY chip.

Generally, NIC 904 may include one or more ports, each comprising an instance of transceiver PHY circuitry 906. NIC 904 includes circuitry for implementing a packet processing pipeline 928. This circuitry may include pre-programmed logic (e.g., an Application Specific Integrated Circuit), programmable logic (e.g., a Field Programmable Gate Array), embedded software/firmware running on one or more processing elements, or any combination of these. NIC 904 may also include circuitry/logic for implementing one or more layers in an Rx network stack 930 and a Tx network stack 932. For example, these network stacks may include one or more layers above the MAC layer, such as the network layer and transport layers. NIC 904 further includes a PCIe interface 934 and a Direct Memory Access (DMA) block 936.

Compute Node 902 includes a System on a Chip (SoC) 938 having a central processing unit (CPU) 940 including multiple cores. Generally, there may be one or more types of cores, as are known in the art. The cores may include caches, such as L1 and L2 caches (not shown). SoC 938 may further include a shared cache, such as a last layer cache (LLC) or L3 cache. Various components on SoC 938 are interconnected via interconnect structures that are collectively depicted as interconnects 942. The interconnect structure may comprise an interconnect hierarchy having multiple levels with applicable bridges or the like to facilitate communication between different protocols when such protocols are implemented at different levels. These protocols include PCIe, with SoC 938 including one or more PCIe interfaces, such as PCIe interface 946 which is coupled to PCIe interface 934. SoC 938 also has one or more memory interfaces 944, such as integrated memory controller(s) (iMC). The iMC is connected to memory 948, which is representative of one or more memory devices having various form factors. Generally, the memory devices may be mounted to a system board or the like to which SoC 938 is mounted, or may include memory modules or the like, such as DIMMs (Dual In-line Memory Modules), SODIMMs (Small Outline Dual In-line Memory Modules), or CAMM (Compression Attached Memory Module) memory modules. During operation, NIC 904 uses DMA block 936 to directly write data to and directly read data from memory 948 without requiring use of CPU 940.

In some embodiments, circuitry in the dashed block comprises a host 950, with the circuitry mounted on or otherwise deployed on a circuit board or the like that is separate from a circuit board used for NIC 904. For example, NIC 904 may be implemented as a PCIe board that is installed in a PCIe expansion slot on the system board used for compute node 902. Under other embodiments, the circuitry for host 950 and NIC 904 are mounted on a single board. In some embodiments, NIC 904 comprises an SoC, with transceiver PHY circuitry 906 comprising embedded circuitry on the SoC rather than implemented in a separate PHY chip or PHY/MAC chip.

System architecture 900 further includes a link partner 952 including an Rx port 554 and a Tx port 556. As shown, compute node 902 and link partner 952 are linked in communication via an Ethernet link 958 supporting bi-directional communication. Generally, link partners may take various forms, such as but not limited to pairs of compute nodes, pairs of NICs, pairs of infrastructure processing units (IPUs) or data processing units (DPUs), or a mixture of these (e.g., compute node to NIC/IPU/DPU, NIC to switch port implementing LSP, etc.)

In addition to compute platforms having processors/SoCs with CPUs, the teaching and principles disclosed herein may be applied to Other Processing Units (collectively termed XPUs) including one or more of Graphic Processor Units (GPUs) or General Purpose GPUs (GP-GPUs), Tensor Processing Units (TPUs), DPUs, IPUs, Artificial Intelligence (AI) processors or AI inference units and/or other accelerators, FPGAs and/or other programmable logic (used for compute purposes), etc. While some of the diagrams herein show the use of CPUs, this is merely exemplary and non-limiting. Generally, any type of XPU may be used in place of a CPU in the illustrated embodiments. Moreover, the term “processor” is used to generically cover CPUs and various forms of XPUs.

Generally, the teachings and principles disclosed herein may apply to other PAM encoding schemes in combination with QAM constellations. Under such schemes, the unused constellation points may be used to convey data in parallel with the QAM transmission.

While various embodiments described herein use the term System-on-a-Chip or System-on-Chip (“SoC”) to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various embodiments of the present disclosure, a device or system can have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems the various dies, tiles and/or chiplets can be physically and electrically coupled together by a package structure including, for example, various packaging substrates, interposers, active interposers, photonic interposers, interconnect bridges and the like. The disaggregated collection of discrete dies, tiles, and/or chiplets can also be part of a System-on-Package (“SoP”).

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Various components described herein may be a means for performing the functions described. The operations and functions performed by various components described herein may be implemented by software/firmware executing on one or more processing elements, via embedded hardware or the like, or any combination of hardware and software. As used herein, embedded logic includes but is not limited means for performing the associated operations and logic, such as through use of preprogrammed logic (e.g., ASICs), programmable logic (e.g., FPGAs), and/or other types of embedded hardware configured to perform associated functionality. Such components may be implemented as software modules, hardware modules, special-purpose hardware (e.g., application specific hardware, ASICs, DSPs, FPGAs, etc.), embedded controllers, hardwired circuitry, hardware logic, etc. Software and/or firmware content (e.g., data, instructions, configuration information, etc.) may be provided via an article of manufacture including non-transitory computer-readable or machine-readable storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method comprising:
implementing a PAM (Pulse Amplitude Modulation) 6 (PAM6) modulation scheme utilizing 36 constellation points comprising a multiplex of 32-QAM and shifted 32-QAM constellations, each comprising 32 PAM6 symbols; and
transmitting 32-QAM and shifted 32-QAM constellations utilizing the PAM6 modulation scheme to send payload data and convey supplementary data in parallel.

2. The method of claim 1, where each 5 bits of payload data are mapped to 32 out of 36 constellation points of a 32-QAM or shifted 32-QAM constellation, representing 2 consecutive symbols.

3. The method of claim 1, further comprising:
implementing 4 out of the 32 32-QAM constellation points as conveyors; and
implementing 4 constellation points of the 36 constellation points that are not among the 32 constellation points in the 32-QAM constellation as shifted constellation points, wherein a shifted 32-QAM constellation includes at least one shifted constellation point.

4. The method of claim 3, wherein the 36 constellation points are configured in a 6×6 grid and wherein the 32-QAM constellation comprises:
a first row skipping the first and sixth constellation points;
second through fifth rows including all six constellation points in these rows; and
a last row skipping the first and sixth constellation points.

5. The method of claim 3, wherein each of the 4 conveyors has an associated shifted constellation point that is adjacent to it.

6. The method of claim 3, further comprising:
at a receiver,
in response to receiving a conveyor,
outputting a supplementary data bit of ‘0’; and
demapping 5-bits of payload data associated with the conveyor.

7. The method of claim 3, further comprising:
at a receiver,
in response to receiving a shifted constellation point,
outputting a supplementary data bit of ‘1’; and
demapping 5-bits of payload data for the shifted constellation point.

8. The method of claim 1, further comprising utilizing the supplementary data to provide error correction of the payload data.

9. The method of claim 7, further comprising using the supplementary data to implement two levels of protection, a first level using a first code protecting the payload data and a second level using a second code to protect the supplementary data.

10. The method of claim 1, further comprising using the supplementary data to communicate between link partners comprising a transmitter transmitting data to a receiver.

11. An apparatus, comprising a transmitter configure to:
implement a PAM (Pulse Amplitude Modulation) 6 (PAM6) modulation scheme utilizing 36 constellation points comprising a multiplex of 32-QAM and shifted 32-QAM constellations, each comprising 32 PAM6 symbols;
receive a stream of payload data;
receive a stream of supplementary data or generate supplementary data as a function of associated payload data; and
generate and transmit 32-QAM and shifted 32-QAM constellations utilizing the PAM6 modulation scheme to send payload data and convey supplementary data in parallel to a link partner.

12. The apparatus of claim 11, where each 5 bits of payload data are mapped to 32 out of 36 constellation points of a 32-QAM or shifted 32-QAM constellation, representing 2 consecutive symbols.

13. The apparatus of claim 11, wherein the transmitter is further configured to:
implement 4 out of the 32 32-QAM constellation points as conveyors; and
implement 4 constellation points of the 36 constellation points that are not among the 32 constellation points in the 32-QAM constellation as shifted constellation points, wherein a shifted 32-QAM constellation includes at least one shifted constellation point.

14. The apparatus of claim 13, wherein the transmitter adds bits of data from the supplementary data stream as latent data in a 32-QAM or shifted 32-QAM constellation, wherein,
to encode a bit of supplementary data as a ‘0’, payload data for a constellation point comprising a conveyor is untouched; and
to encode a bit of supplementary data as a ‘1’, payload data for a constellation point comprising a conveyor is shifted to a shifted constellation point associated with that conveyor.

15. The apparatus of claim 11, wherein the transmitter is configured to:
generate supplementary data comprising an error code for an associated block of payload data, the error code being conveyed as supplementary data in parallel with sending of the associated block of payload data.

16. An apparatus, comprising a receiver configure to:
implement a PAM (Pulse Amplitude Modulation) 6 (PAM6) modulation scheme utilizing 36 constellation points comprising a multiplex of 32-QAM and shifted 32-QAM constellations, each comprising 32 PAM6 symbols;
receive 32-QAM and shifted 32-QAM constellations transmitted from a transmitter comprising a link partner, the 32-QAM and shifted 32-QAM constellations containing payload data and conveying latent supplementary data;
demap the payload data from the 32-QAM and shifted 32-QAM constellations; and
extract the latent supplementary data from the 32-QAM and shifted 32-QAM constellations.

17. The apparatus of claim 16, where each 5 bits of payload data are mapped to 32 out of 36 constellation points of a 32-QAM or shifted 32-QAM constellation, representing 2 consecutive symbols.

18. The apparatus of claim 16, wherein under the PAM6 modulation scheme:
4 out of the 32 32-QAM constellation points are implemented as conveyors; and
4 constellation points of the 36 constellation points that are not among the 32 constellation points in the 32-QAM constellation are implemented as shifted constellation points, wherein a shifted 32-QAM constellation includes at least one shifted constellation point.

19. The apparatus of claim 18, wherein the receiver is further configured to:
in response to receiving a conveyor,
output a supplementary data bit of ‘0’; and
demap 5-bits of payload data associated with the conveyor; and
in response to receiving a shifted constellation point,
outputting a supplementary data bit of ‘1’; and
demap 5-bits of payload data for the shifted constellation point.

20. The apparatus of claim 16, wherein the latent supplementary data comprises at least one level of error correction code for protecting associated payload data, and wherein the receiver is configured to:
utilize latent supplementary data extracted from the 32-QAM and shifted 32-QAM constellations to perform at least one level of error correction check of the associated payload data.
